(19) United States
(12) Patent Application Publication
(10) Pub. No.: US 2015/0071057 A1
(43) Pub. Date: Mar. 12, 2015

(54) SEGMENT RECOVERY

(71) Applicants: Daniele Ceccarelli, Genova (IT); Diego Caviglia, Savona (IT); Paolo Rebella, Bergeggi (IT)

(72) Inventors: Daniele Ceccarelli, Genova (IT); Diego Caviglia, Savona (IT); Paolo Rebella, Bergeggi (IT)

(73) Assignee: TELEFONAKTIEBOLAGET L M ERICSSON (publ), Stockholm (SE)

(21) Appl. No.: 13/996,819

(22) PCT Filed: Apr. 18, 2011
(86) PCT No.: PCT/EP2011/056073

§ 371 Date: Nov. 8, 2013

(30) Foreign Application Priority Data
Dec. 21, 2010 (EP) 10 196 166.2

(51) Int. Cl. H04L 12/24; H04L 12/703

(52) U.S. Cl. CPC H04L 41/0668; H04L 45/28
USPC 370/228

(57) ABSTRACT

In a communications network, a recovery segment is used to reroute a recoverable part of a path set up along an original route along links between nodes. When a defect is detected in the original route of the path, but is undetectable by nodes within the recoverable part, a reroute message is sent (5) from outside the recoverable part to an end node (N2,N4) of the recoverable part. This prompts the rerouting of the recoverable part over the recovery segment. Thus segment recovery becomes possible for these defects which cannot be detected at nodes in the segment. This extends the applicability of benefits of segment recovery such as reduced resources devoted to recovery, and flexibility to choose which parts of paths to protect. The end node can send a notify message beforehand, to request (3) notification of the defect as the reroute message.

### TECHNICAL FIELD

This invention relates to methods of using a recovery segment to reroute a recoverable part of a path set up between nodes of communication networks, to corresponding nodes operable as ingress nodes, as egress nodes, or as nodes at either end of the recovery segment, and to corresponding computer programs for controlling such nodes.

### BACKGROUND

Optical Transport Networks such as those specified in the ITU-T G.709 recommendation are known, having a control plane to control nodes of such networks to reserve (set up) new paths by sending messages between the nodes to reserve resources at each node.

Classical RSVP (Resourse reSerVation Protocol) [RFC2205] signaling protocol is a known protocol for messages sent between nodes to set up new paths. RSVP-TE (RSVP-Traffic Engineering) [RFC3209] extends RSVP in order to provide a way to establish Label Switched Paths (LSPs) in MPLS (Multi-Protocol Label Switching). To reserve a path, an RSVP-TE (Traffic Engineering) PATH message, in the form of a Generalized Label Request, is sent out from the first node (which acts as an ingress node) via intermediate nodes along the proposed path, to the last node (acting as an egress node). The egress node returns an RSVP-TE RESV message to the ingress node, back along the path to cause the nodes along the path to confirm the reservation of resources such as bandwidth on switch paths and ports, for the requested path, for traffic of a signal type specified in the message.

It is non reliable in the sense that it relies on other mechanisms if a message is lost. It can recover from message lost via RSVP refresh messages. For example, if the sole tear down message transmitted is lost, then resources will only be deallocated once the “cleanup timer” interval has passed.

RSVP-TE does not change the intrinsic RSVP unreliability described above. GMPLS (Generalized MPLS) [RFC3945] generalized the concept of LSP. An LSP became regarded as meaning “any possible form of connection which someone is willing to control”. Again, GMPLS does not change the intrinsic RSVP unreliability aspect.

The concept of a distributed Control Plane architecture providing, among others, signaling functions to dynamically set up/tear down LSPs over an underlying data transport network, introduces flexibility in allocation of network resources. This leads to an optimized on-demand bandwidth usage, ensuring network efficiency and allowing for greater scalability of topology.

On the other hand, the lack of a centralized control plane entity able to “see” and control the whole network, requires that single NEs are able to exchange all the information needed to stay aligned with each other and to keep their view of the underlying data plane consistent and up to date.

It is known to provide end to end recovery of an LSP if a node fails after the path has been set up, as shown in RFC 4782: RSVP-TE Extensions in Support of End-to-End Generalized Multi-Protocol Label Switching (GMPLS) Recovery.

It is also known to use a segment recovery procedure according to RFC 4873: GMPLS Segment Recovery, for recovering a part of a path.

### SUMMARY

An object of the invention is to provide improved apparatus or methods. According to a first aspect, the invention provides:

A method of using a recovery segment to reroute a recoverable part of a path set up along an original route along links between nodes of a communications network, by detecting a defect in the original route of the path, using a node on the path and outside the recoverable part of the path, the defect being undetectable by nodes within the recoverable part, and sending a reroute message to one or both nodes at a start and end of the recoverable part. The reroute message is received at the one or both nodes and it prompts them to carry out the rerouting of the recoverable part over the recovery segment in response to receipt of the reroute message.

By having a reroute message, segment recovery becomes possible for these defects which cannot be detected at nodes in the segment. This extends the benefits of segment recovery to a wider range of circumstances. Hence benefits such as reduced resources devoted to recovery, and flexibility to choose which parts of paths to protect, can now be applied more widely.

Another aspect provides a node for a communications network, the network being arranged to have paths set up over links between nodes of the network, the node having: a processor arranged to control use of a recovery segment to reroute a recoverable part of a path set up along an original route along links between the node and other nodes of the communications network. The node can be an ingress or egress node and have a detector for detecting a defect in the original route of the path, for the case that the node is outside the recoverable part of the path, and the defect being undetectable by nodes within the recoverable part. In response to the detecting of the defect, the processor is arranged to cause a reroute message to be sent to one or both nodes at ends of the recoverable part, to reroute the recoverable part using the recovery segment.

Another aspect of the invention provides a node for a communications network, the network being arranged to have paths set up over links between nodes of the network, the node being operable as an end node of a recovery segment. It can have a routing part arranged to rerouting a recoverable part of a path from an original route along links between the node and other nodes of the communications network, to use a recovery segment, for the case that the node is at one end of the recoverable part, and a processor. The processor can be arranged to recognise a reroute message received from another node outside the recoverable part of the path, and in response to the reroute message, control the routing part to reroute the path to use the recovery segment.

Another aspect of the invention provides a computer program on a computer readable storage medium having instructions for controlling a node of a communications network and which when executed by a processor of the node cause the node to control use of a recovery segment to reroute a recoverable part of a path set up along an original route along links between the node and other nodes of the communications network, by recognising an input indicating a detection of a defect in the original route of the path, for the case that the node is outside the recoverable part of the path, and the defect is undetectable by nodes within the recoverable part. In response to the indication of the defect, it can cause a reroute message to be sent to one or both nodes at ends of the recoverable part, to reroute the recoverable part using the recovery segment.

Another aspect of the invention provides a computer program on a computer readable storage medium having instructions for controlling a node of a communications network located at an endpoint of a recoverable part of a path, such that when the instructions are executed by a processor of the node, cause the processor to recognise a reroute message received from another node outside the recoverable part of the path. In response, it can be arranged to reroute the recoverable part from an original route along links between the node and other nodes of the communications network, onto a recovery segment.

Any additional features can be added to these aspects, or disclaimed from them, and some are described in more detail below. Any of the additional features can be combined together and combined with any of the aspects. Other effects and consequences will be apparent to those skilled in the art, especially over compared to other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of a sequence of messages passed between nodes based on a conventional protocol,

FIGS. 2 to 4 show schematic views of nodes and a path with an associated recovery segment,

FIGS. 5 to 13 show time charts of examples of parts of a recovery procedure according to embodiments, and

FIG. 14 shows an example of nodes which can implement the procedures of FIGS. 5 to 14, or other embodiments.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

### DEFINITIONS

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Elements or parts of the described nodes or networks may comprise logic encoded in media for performing any kind of information processing. Logic may comprise software encoded in a non transitory manner on a disk or other computer-readable medium and/or instructions encoded in an application specific integrated circuit (ASIC), field programmable gate array (FPGA), or other processor or hardware.

References to nodes can encompass any kind of switching node, not limited to the types described, not limited to any level of integration, or size or bandwidth or bit rate and so on.

References to software can encompass any type of programs in any language executable directly or indirectly on processing hardware.

References to hardware, processing hardware or circuitry can encompass any kind of logic or analog circuitry, integrated to any degree, and not limited to general purpose processors, digital signal processors, ASICs, FPGAs, discrete components or logic and so on.

### SOME ABBREVIATIONS

### DWDM: Dense Wavelength Division Multiplexing

### GMPLS Generalized Multi Protocol Label Switching

### IETF Internet Engineering Task Force

### LSP Label Switched Path

### NE Network Element

### RFC Request For Comment

RSVP ReSource reserVation Protocol
RSVP-TE ReSource reserVation Protocol-Tunnel Extensions

### REFERENCES

RFC 3473: Generalized Multi-Protocol Label Switching (GMPLS) Signaling Resource ReserVation Protocol-Traffic Engineering (RSVP-TE) Extensions
RFC 4782: RSVP-TE Extensions in Support of End-to-End Generalized Multi-Protocol Label Switching (GMPLS) Recovery
RFC 4873: GMPLS Segment Recovery
RFC 5710: PathErr Message Triggered MPLS and GMPLS LSP Reroutes

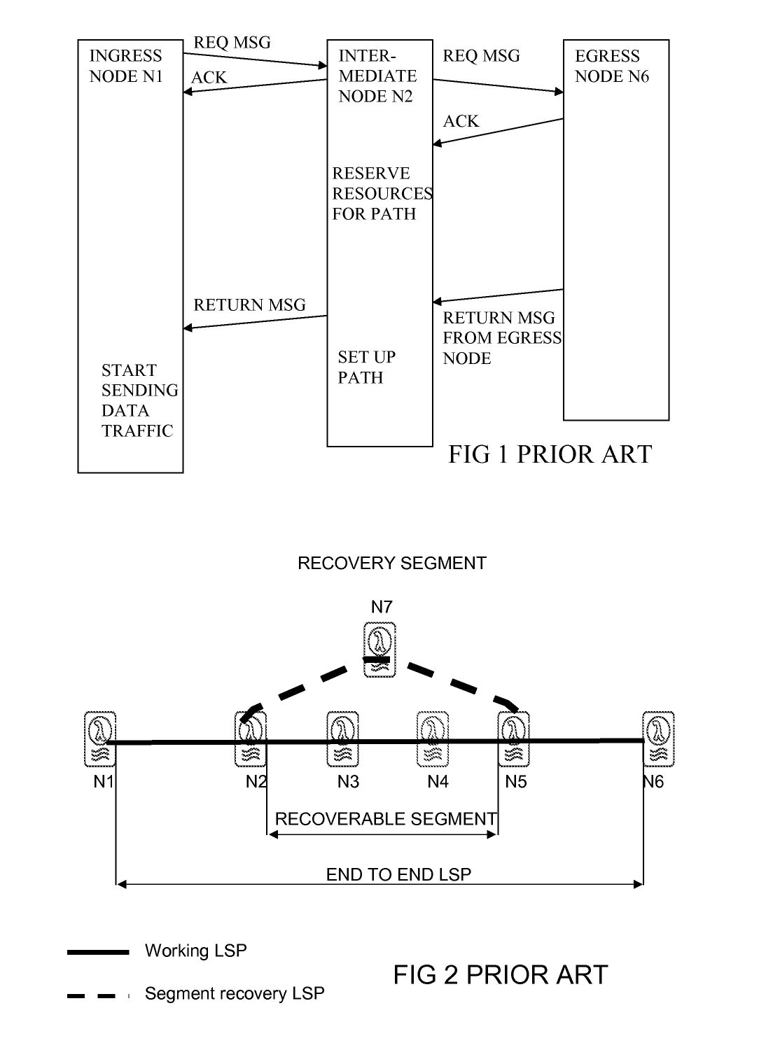

### FIG. 1, Conventional Sequence of Messages to Set Up an LSP

By way of introduction to the embodiments, some issues with conventional designs will be explained.

FIG. 1 shows a schematic view of a sequence of messages passed between nodes based on a conventional protocol, such as Generalized Multi Protocol Label Switching (GMPLS) which is the preferred choice for implementing a control plane for optical and transport network; The left hand block represents an ingress node N1, the middle block represents one of many intermediate nodes N2, and the right hand block represents an egress node N6. A sequence of messages between the nodes is shown by arrows, with time flowing down the figure. A request message (such as an RSVP PATH message) is sent from the ingress node to the intermediate node along the path being set up. The intermediate node returns an acknowledgement message and passes the request message on to the next intermediate node and eventually to the egress node. The egress node sends a return message (such as an RSVP RESV message) back along the path to cause the nodes to use the reserved resources to set up the path. Each node responds to the return message to set up the path and pass the message along the path until it reaches the ingress node. The ingress node now knows the path is set up and can start sending data traffic along the path.

Examples of control planes can use Generalized Multi-Protocol Label Switching (GMPLS), which extends MPLS from supporting Packet Switching Capable (PSC) interfaces and switching to include support of four new classes of interfaces and switching: Layer-2 Switching (L2SC), Time-Division Multiplex (TDM), Lambda Switch (LSC), and Fiber-Switch (FSC) Capable.

A functional description of the extensions to MPLS signaling that are needed to support these classes of interfaces and switching is provided in RFC3471, while RFC3473 describes the ReSource reserVation Protocol (RSVP-TE) specific formats and mechanisms needed to support all four classes of interfaces. RFC 4328 presents the technology details that are specific to G.709 Optical Transport Networks (OTN). Such parameters are carried through the signaling protocol in dedicated traffic parameter objects. Moreover RFC 4328 defines how to encode such labels when these G.709 traffic parameters are used. G.709 defines several networking layers constituting the optical transport hierarchy. RFC 4328 adapts GMPLS to control G.709 type OTNs, creating a Digital Path layer, an Optical Path layer and a label space structure enabling the identification of the exact position of a particular signal in a multiplexing structure. Thus, the GMPLS signaling extensions for G.709 need to cover the messages such as Generalized Label Requests, used to request capacity at nodes along the path as well as the specific technology dependent objects included in the so-called traffic parameters for SONET/SDH networks. Moreover, RFC 4328 also proposes a label space definition suitable for that purpose.

The Generalized Label Request is a message used by RSVP-TE for the signaling of a Label Switched Path (LSPs) on any kind of network technology. It is defined in RFC3471 and extended in RFC 4328 in order to support G.709 OTN architecture. It includes a common part (i.e., used for any switching technology) and a technology dependent part (i.e., the traffic parameters). RFC 4328 extends both parts to accommodate GMPLS Signaling to the G.709 transport plane recommendation. GMPLS foresees among other features the possibility for both end to end and segment recovery. IETF standard references are RFC 4873 for segment recovery and RFC 4872 for end to end recovery. LSP recovery is recognized as being commercially valuable applied to GMPLS control planes in transport networks, and is also applicable to other types of networks, particularly to any other transport technologies such as DWDM networks. As will be explained, embodiments can extend segment recovery to networks where some defects are not detectable at all nodes, for example optical networks where optical impairments cause data errors which are not detectable at optical switching nodes, only at nodes having regeneration, and at optical termination at Ingress/Egress nodes.

### FIGS. 2 to 4 Show Schematic Views of Part of a Network

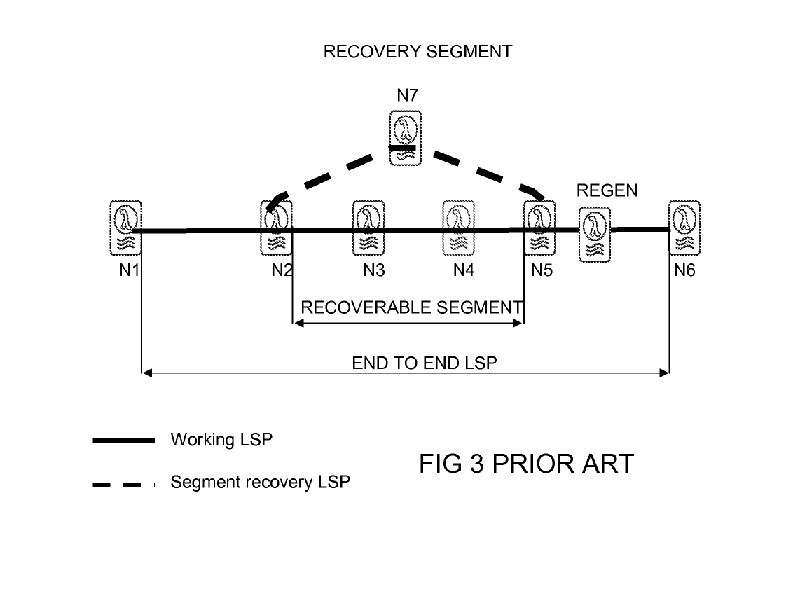

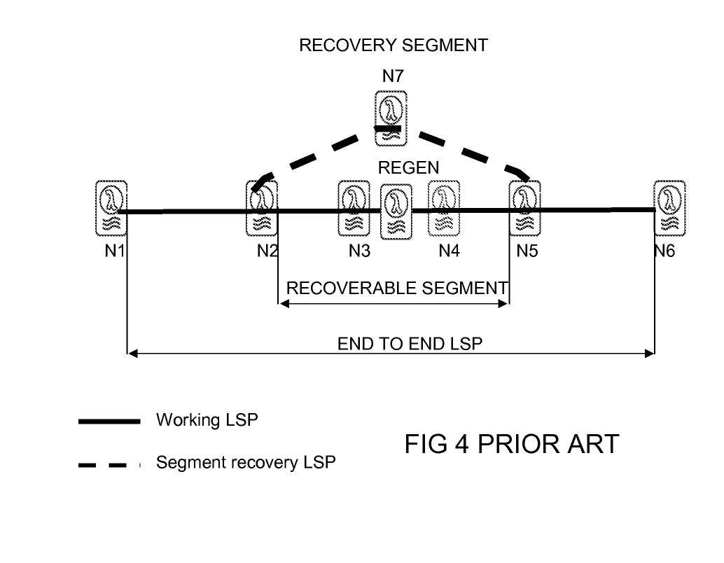

FIGS. 2 to 4 show schematic views of part of a network to illustrate three possible cases of GMPLS based segment recovery in a photonic network:
1. Segment recovery without regeneration (FIG. 2)
2. Segment recovery with regeneration outside the recovery domain (protected segment) (FIG. 3)
3. Segment recovery with regeneration inside the recovery domain (protected segment) (FIG. 4)
Where:
   N1 is called a Ingress Node
   N2 is called a Branch Node, and is at the start of the recoverable part of the path,
   N5 is called a Merge Node, and is at the end of the recoverable part,
   N6 is called an Egress Node
   R is a regeneration site, or anywhere that defects can be detected,
   N3 and N4 are other nodes within the recoverable part of the path
   N7 is a node on the recovery segment

Procedure and messages used to create both the worker and the segment recovery LSP are illustrated in RFC 4873 and RFC 4873 does not modify the recovery procedure defined in RFC 4872.

The branch node starts the recovery procedure when either it detects a failure/degrade in the data plane or receives a Notify message from one of the nodes that are part of the recoverable segment, that is, as shown in FIG. 2 for reference, N3 N4 and N5. Conventionally such segment recovery cannot be used to overcome defects for LSPs, especially for DWDM networks, if the defect can be detected only at Ingress/Egress point of the LSP. This is because there is no established way of requesting the branch node to carry out the segment recovery.

Hence existing segment recovery can only be applied to Case 3 of the above described reference networks, because a regeneration node, terminating and regenerating the traffic, can detect a problem at the data plane level (e.g. signal degrade) and notify the branch node about it. In Case 3 the regeneration node, being part of the recovery domain, notifies the branch node about the failure and allows it to perform the segment recovery procedure. In cases 1 and 2, the node informed about the failure is the ingress one, but there is no way for it to tell the branch node to perform the recovery procedure. On the other hand case 2 is partially covered in the sense that RFC 3473 allows node R to send a Notify message to the Ingress node regarding the signal degrade but does not allow the Ingress node to request a recovery procedure to Branch node, so Case 2 can be assimilated to Case 1, where the nodes being able to detect a signal degrade are just Ingress and Egress one but there is no means to tell the branch node to perform the recovery procedure.

In other words, the existing segment recovery standard document, RFC 4873, does not cover the case where LSP defects are detected outside the segment recovery scope but that can be recovered by a segment recovery activation; a clear example of these kind of defect is the signal degrade case where bit errors are caused by optical impairments for example. In cases 1 and 2 there is no way for Branch/Merge nodes to detect a signal degrade, only Ingress/Egress nodes are able to detect the LSP signal degrades either directly (Case1) or via notification (Case2), but RFC 4873 does not foresee any mechanism/message to inform the Branch node that it must activate the recovery LSP.

Hence there is either a permanent degradation of traffic, or.

The problem arises due to the fact that even if RFC 4872 foreseen a mechanism, using Notify messages, to force the activation of the recovery LSP in case of signal degrade (section 6.2) the segment recovery RFC 4873 does not update this behavior to take care of the fact in segment recovery procedures the node able to detect the signal degrade and the node in charge of activating the recovery are not the same, this ID will fill this gap in the standards.

### Introduction to Segment Recovery Procedure According to Embodiments

Some embodiments are based on modifying the RSVP-TE Notify message behavior defined by RFC3473, RFC4872 and RFC4873 in order to introduce a direct communication mechanism between the Ingress/Egress node and the Branch node, to activate the recovery segment. One way to do this without making major changes to the standards is to enable the Branch node to send a request message in the form of for example a Notify Message modified to add a NOTIFY_REQUEST object into the message. This can enable the branch node to ask one or both of the Ingress and Egress nodes to notify the branch node about a defect, and include a request to reroute. This can overcome the lack of a message able to force the branch node to activate the recovery without such a request message.

This applies where the defect is not detectable by nodes inside the recovery segment. For example an optical network with only optical switching in the recoverable segment and no regen, means that bit errors without loss of optical signal cannot be detected in the segment. Other examples can be envisaged, for example if paths are multiplexed in other ways, such as by time slot or frequency, and the nodes in the recoverable segment can switch by timeslot or frequency, but not access bit level information to detect bit errors.

In some embodiments, if compatibility with existing standards is not an issue, a branch node can be arranged to recognize and react to the same reroute message, or a new reroute message without needing to send the request message. This can make the procedure simpler and quicker, but is less compatible with existing standards. The ingress or egress nodes, or an intermediate node would need to be modified to enable them to send such a reroute message without needing a request from the branch node. In principle this would enable a segment recovery procedure to be forced to force the branch to reroute the path.

### Request Message Example

Each message in GMPLS has a field called TYPE which is used to identify the type of message being sent (path, resv, path tear, path err, notify, etc). In case of the NOTIFY message, some information indicating the purpose of the notification can be carried within the “Value” field of the messages. Some values have already been defined, and others have been left undefined, for future use.

It would be possible to use different types and formats of messages, but that wouldn't be compatible with the GMPLS standards. As one way of implementing the request message, a Notify message is modified by the addition of a NOTIFY_REQUEST object as follows:

```
<Notify message>::= <Common Header> [<INTEGRITY>]
  [ [<MESSAGE_ID_ACK> | <MESSAGE_ID_NACK>] ... ]
  [ <MESSAGE_ID> ]
  <ERROR_SPEC> <notify session list>
  <NOTIFY_REQUEST>
```

### Where

NOTIFY_REQUEST obj contains the address of the Branch node
ERROR_SPEC obj
   ERROR_CODE: 34 Reroute (defined in RFC 5710)
   ERROR VALUE: 2 Request me to reroute (defined here)
Notify session list: indicates the LSP identifier and is unmodified by this proposal
Error Value 2 is newly defined by this proposal.

Ingress/Egress nodes receiving this message are able to send reroute messages in the form of Notify messages requesting segment recovery activation to the corresponding branch node whose address is indicated in the request as shown above.

The branch node will send the Notify Message with the NOTIFY_REQUEST object:
as soon as the segment recovery LSP has been successfully signaled in case the recovery scheme foreseen a pre-planned recovery LSP
or as soon as the worker LSP has been successfully set-up in the case the recovery scheme is full rerouting.

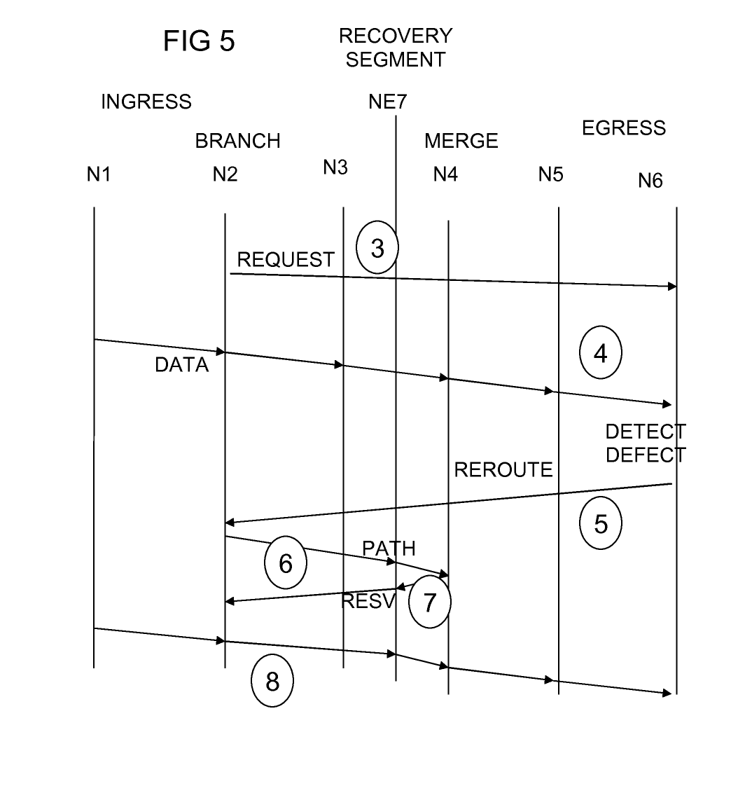

### FIG. 5, Time Chart of Segment Recovery According to an Embodiment

FIG. 5 shows a time chart of one embodiment, with time flowing down the page, for a part of a network similar to that of FIGS. 2 to 4, except that N4 is the merge node rather than N5. At the start, worker and recovery LSPs are up and running, in case a full end to end recovery is needed. A recovery segment using N2,N4,N7 is reserved but not used. There can be many paths multiplexed over the same nodes, multiplexed by wavelength, by time slot, by frequency and so on. At step 3, a Branch node N2 asks for Notification by sending a request message in the form of the Notify Message with the defined NOTIFY_REQUEST object as explained above.

At step 4, the path is being used to send payload data from the ingress node to the egress node. The egress node detects a defect, either by direct detection or by Notify message from a regeneration site outside the segment recovery domain (as shown in FIG. 3). This prompts the egress node at step 5 to send a reroute message to the branch node to cause the Branch node to reroute the path. At step 6, the Branch node activates the reserved recovery segment or creates a new recovery segment. Activating can follow a similar procedure to that of FIG. 1, in which the branch node sends an RSVP PATH message to the intermediate nodes along the segment being set up. Each intermediate node returns an acknowledgement message and passes the RSVP PATH message on to the next intermediate node and eventually to the merge node. The merge node sends a return message (such as an RSVP RESV message) back along the path at step 7, to cause the nodes to use the reserved resources to set up the recovery segment. Each node responds to the return message to set up the path and passes the message along the path until it reaches the branch node. There is no need for any modification of the standard PATH and RESV message formats. The PATH and RESV messages include an object called an admin status object with a set of flags. The consequent actions to be performed upon receiving a message are usually indicated by those flags.

The branch node now knows the recovery segment is set up and can switch the data onto the recovery segment to be passed via N2, N7 and N5, instead of N2,N3,N4,N5.

The egress node can then monitor to see if the defect is cured by using the recovery segment. In some cases the defect may not be cured, and then a conventional end to end recovery procedure may be needed. It is usually worthwhile trying a segment recovery first, as it uses less resources, and can be activated more quickly.

This proposed procedure enables segment recovery to be extended to cover cases as shown in FIGS. 2 and 3, where defects are only detectable outside the recoverable part of a path. This is particularly useful for DWDM networks and in network scenarios where an IP router is connected to the DWDM network via a colored interface. It can extend existing GMPLS segment recovery procedure to cope also with these cases where the signal degrade is detected outside the recovery scope.

Defects can encompass bit errors, optical signal degrade, or anything which is detectable at some nodes but not at others. So for instance, a node can typically detect a complete loss of optical signal, or a loss of electrical connection, but if it is switching optically without regen, then it may not be able to detect bit errors, or some types of degradation in the optical signal.

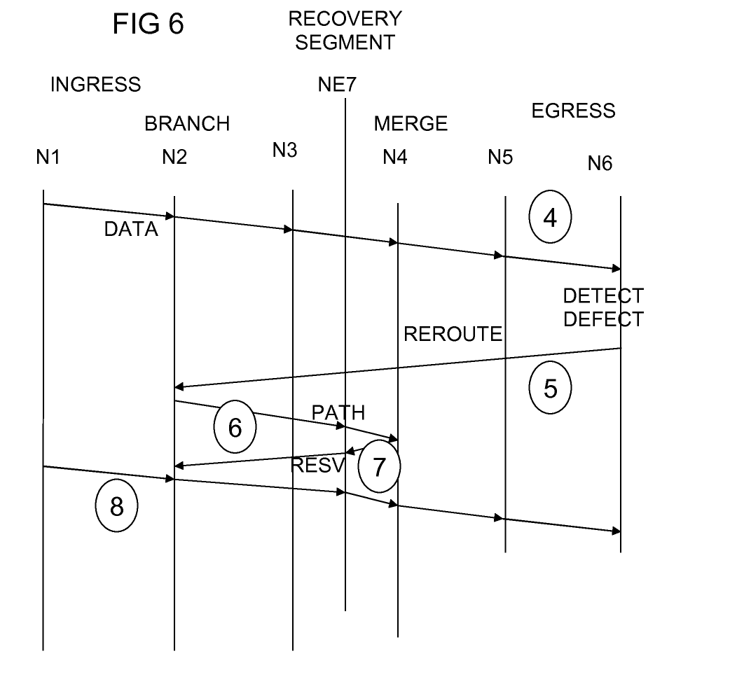

### FIGS. 6 to 12, Time Charts of Other Embodiments

FIG. 6 shows a time chart similar to that of FIG. 5, and showing another embodiment, differing in that no prior request need be sent by the branching node to the egress node.

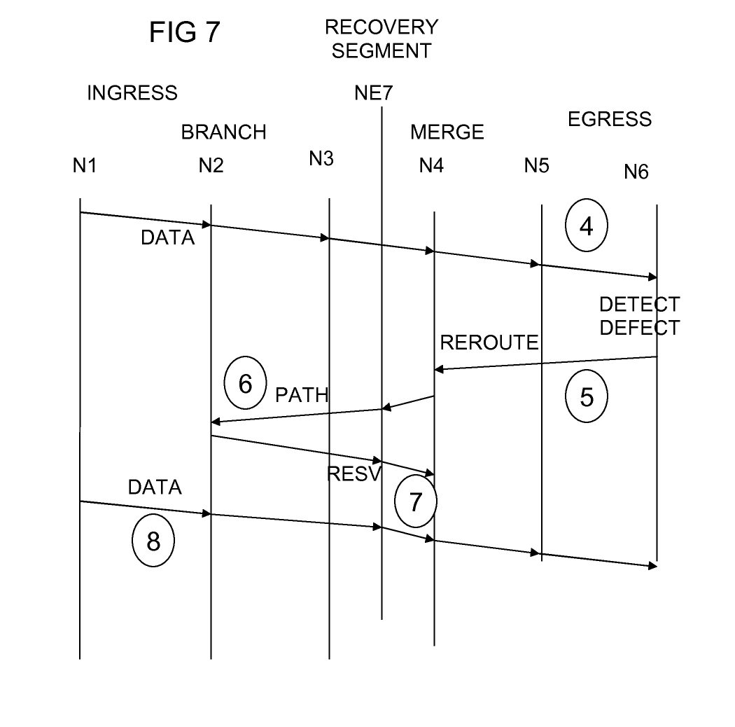

FIG. 7 shows a time chart similar to that of FIG. 6, and showing another embodiment, differing in that instead of the branching node receiving the reroute message, it is received by the merge node and the merge node sends the path message to the other nodes along the recovery segment. Hence anything said above about the branching node, could instead apply to the merge node. No prior request is shown here, but of course it can be present in this or any of the following embodiments.

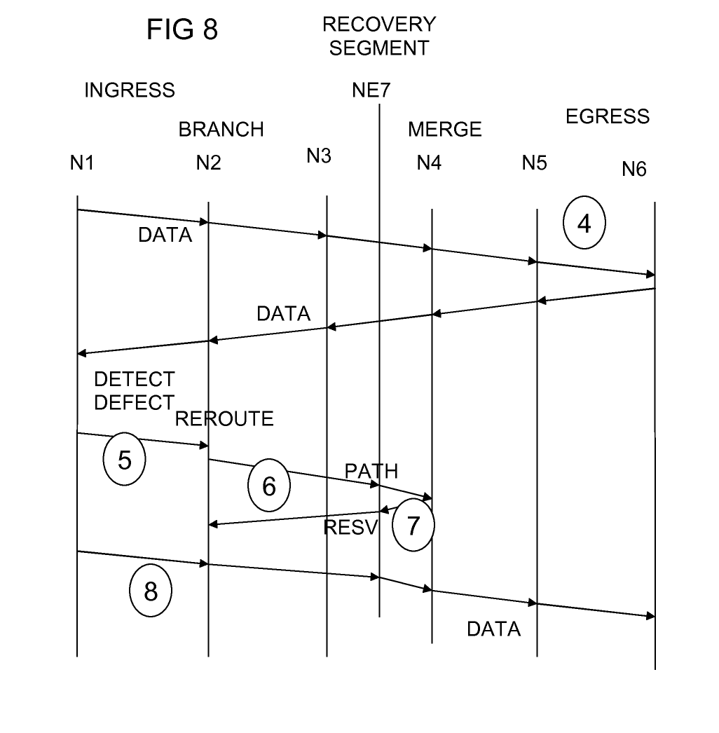

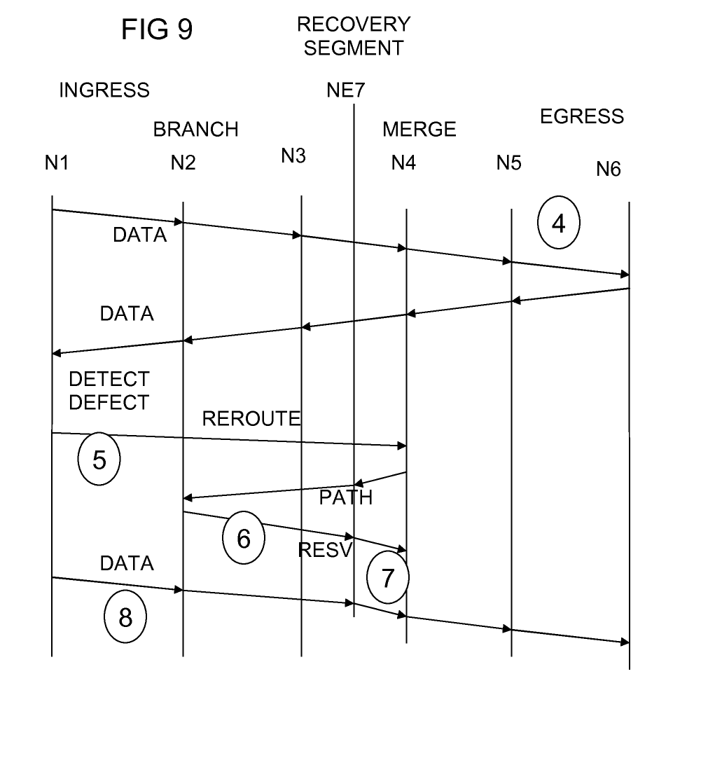

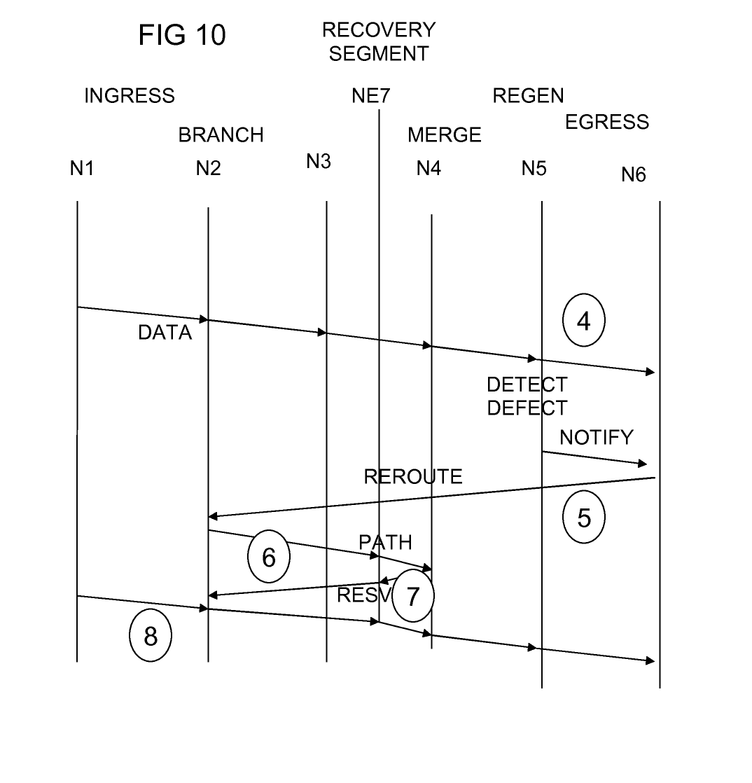

FIG. 8 shows a time chart similar to that of FIG. 6, and showing another embodiment, differing in that the detecting of the defect is done at the ingress node instead of the egress node. This means the detecting is done on data traffic in the other direction. This is feasible as long as the same route is used so that a defect in one direction shows up on signals in the other direction. In practice detection can be used in both directions simultaneously, and either the ingress or the egress node can trigger a segment recovery procedure. Clearly the reroute message can be sent to the merge node as shown in FIG. 7 if the recovery segment is arranged to be controlled by the merge node rather than the branch node. The result is shown in FIG. 9 in a similar time chart. FIG. 10 shows a time chart similar to that of FIG. 6, and showing another embodiment, differing in that the detecting of the defect is now done in the regen located at intermediate node N5, outside the recoverable part of the path. This is similar therefore to the situation shown in FIG. 3. The intermediate node in this case is not able to send a reroute message direct to the end node of the recoverable part, so it notifies the egress node (or the ingress node) and the procedure continues as before. There could be further recoverable parts between N5 and N6, in which case, the detection at the intermediate nodes helps to distinguish which recoverable part is contributing to the defect. The egress (or ingress node) could then compare the defect detections from different intermediate nodes and decide which of the recovery segments to activate.

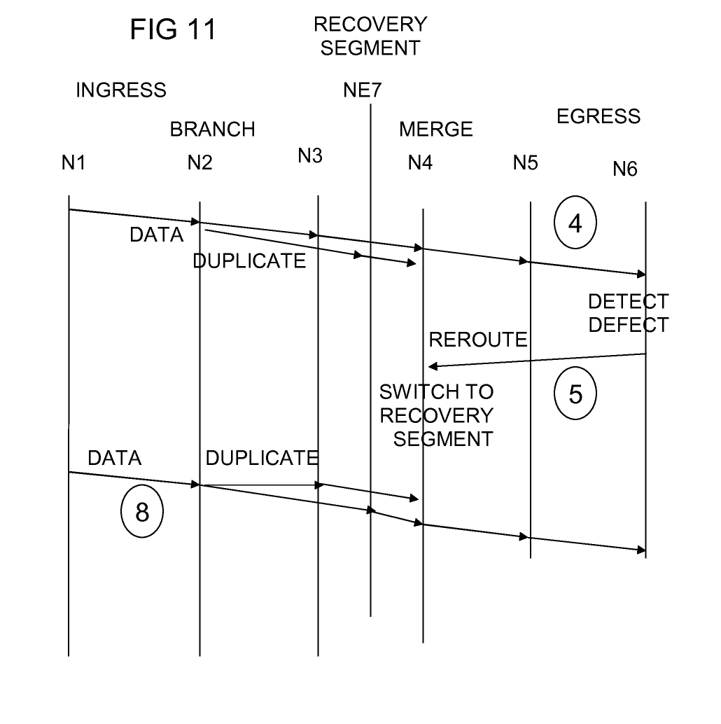

FIG. 11 shows a time chart similar to that of FIG. 6, and showing another embodiment, differing in that the segment recovery is arranged to be switched at the merge node, so the data traffic is continuously duplicated and sent over the recovery segment, so that two versions arrive at the merge node over different routes. The merge node then only need select which to use. This is effectively protection switching and can take place more quickly so that little or no data is lost in the change of route, and no time is lost setting up the recovery route. But it means the recovery segment cannot be shared or used for extra traffic.

As shown in FIG. 11, the reroute message is sent to the merge node, and when received, it switches to cause the version of the data traffic from the recovery segment to be switched through. This arrangement can replace the path message in any of the embodiments described above, and is intended to be encompassed by the use of phrases such as “rerouting of the recoverable part”.

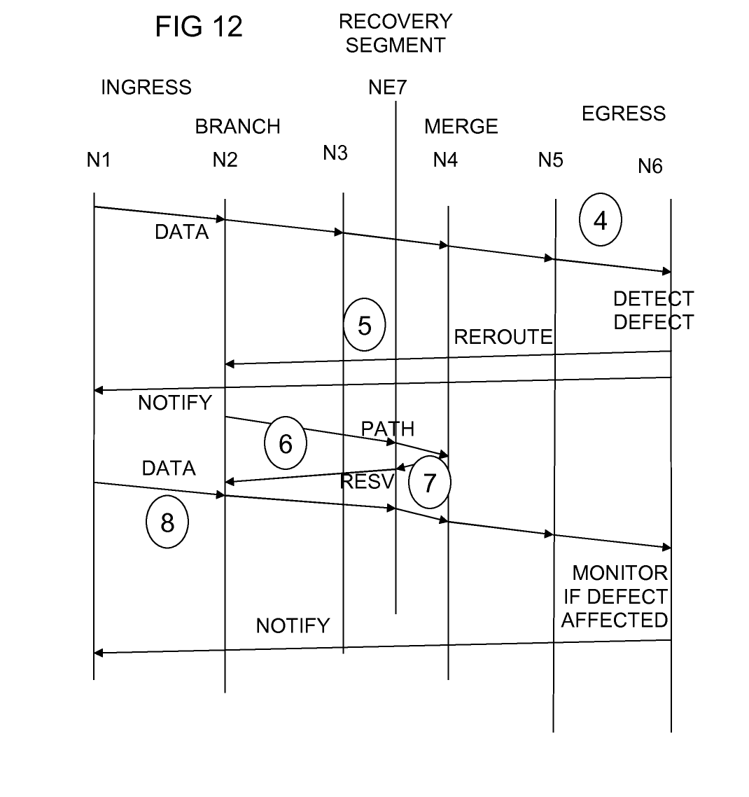

FIG. 12 shows a time chart similar to that of FIG. 6, and showing another embodiment, differing in that the egress node (or any other node where detecting takes place) is arranged to monitor if the defect is affected after the segment recovery procedure has been carried out. The detecting node can then notify the ingress or other controlling node, to take action if needed. Such notification may also take place as shown when a reroute message is sent out, so that the ingress node is aware of any defects and any activated segment recovery.

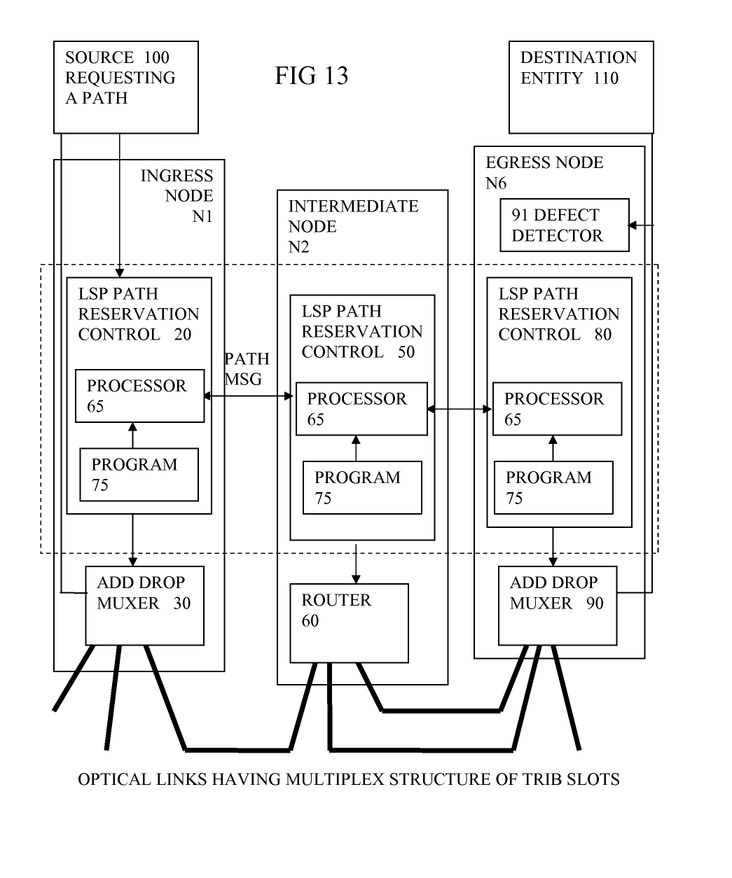

### FIG. 13, Overall View of Nodes According to Embodiments

FIG. 13 shows parts of an optical transport network suitable for carrying out the message passing described above. Three nodes are shown, there can be many more. An ingress node N1 has an LSP path reservation control part 20, which controls an add drop multiplexer part 30. The reservation control part can have a processor 65 and a store having a program 75 for execution by the processor 65. The program can enable the node to act as an ingress node, or in some cases, to act as an intermediate node for other paths started elsewhere. An intermediate node N2 has its own LSP path reservation control part 50, which controls a router 60. Again, the reservation control part can have a processor 65 and a store having a program 75 for execution by the processor 65. The program can enable the node to act as an intermediate node. If the intermediate node had add drop capabilities, then the program could be chosen to make the node act as an ingress or egress node for other paths. An egress node N6 has its own LSP path reservation control part 80, which controls it's add/drop multiplexer 90. Again, the reservation control part can have a processor 65 and a store having a program 75 for execution by the processor 65. The program can enable the node to act as an egress node for the path shown, or as an ingress or intermediate node for other paths. A source entity 100 is shown, as a source of the traffic for which the new path is needed, through the network to a destination entity 110.

Optical links are shown for carrying the traffic between the nodes, and a connection is shown between the control parts of the nodes for passing messages to reserve and to tear down the path. This connection can in principle use either the same or different physical links to those used by the traffic between nodes. The optical links for the traffic can have a multiplex structure of trib slots. A path can use one or more of these trib slots, and a reservation procedure needs to indicate which of these trib slots is reserved.

### Summary of Additional Features

The method can involve sending a request message from the node at either end of the recoverable part, to one or both of an ingress and an egress node of the path, before the defect is detected, to request the reroute message be sent in case of detection of the defect. This makes use of an existing type of message to trigger the reroute, for more compatibility with existing standards.

The request message can comprise a notify message with a notify request object comprising an error value indicating the request to reroute. This is one way of maintaining compatibility with existing standards.

The detecting the defect can be carried out at an egress node of the path. As this is where the path terminates, it is often easier to do detection at this point. The node detecting the defect can be an ingress node of the path, and be arranged to detect using a signal returned from an egress node of the path. This is useful if the path is bidirectional so that a fault in one direction is likely to affect both directions.

The path can comprise an optical path, with regeneration at an intermediate node, outside the recoverable part, the detecting of the defect being carried out at the intermediate node. Regeneration points provide an opportunity for analyzing the traffic electrically and so are useful for detection. Detection at intermediate nodes whether regeneration is carried out or not, is useful to increase confidence in determining where a defect is caused, and if there are multiple recoverable segments, it can help determine which one should be activated.

The intermediate node can be arranged to send a message to one or more of the ingress and egress nodes of the path to cause them to send the reroute message. This can help to maintain compatibility with existing standards, by avoiding the need for a new message to be defined, or to avoid the need for the branch node to be able to recognize messages directly from such intermediate nodes.

The reroute message can be sent to the start of the recoverable part and the rerouting can comprise sending a path message along the recovery segment. This again can help maintain compatibility with existing techniques.

The node which does the detecting can be arranged to receive a request message from the node at either end of the recoverable part before the defect is detected, to request the reroute message be sent in case of detection of the defect.

The node doing the detecting can be an egress node of the path, or an ingress node. The detector can be arranged to monitor if the defect is affected by the rerouting. Where the node is an ingress node of the path, the detector can be arranged to detect using a signal returned from an egress node of the path.

The node having the detector can be an intermediate node. In this case, the path can comprise an optical path, and the intermediate node can have a regenerator for regenerating an optical signal on the optical path.

The node having the detector can be arranged to send a message to one or more of the ingress and egress nodes of the path to cause them to send the reroute message.

The node at one end of the recovery segment can be arranged to send a request message from the node at either end of the recoverable part before the defect is detected, to request the reroute message be sent in case of detection of the defect.

The node at one end of the recovery segment can be operable as a branching node of the recoverable part, or be operable as a merging node of the recoverable part.

The node at one end of the recovery segment can be arranged to carry out the rerouting by sending a path recovery message along the recovery segment to set up the path along the recovery segment. The merge node can be arranged to carry out the rerouting by selecting one or other of duplicate versions of traffic arriving at the node from the recoverable part and from the recovery segment.

Other variations and embodiments can be envisaged within the claims.

1. A method of using a recovery segment to reroute a recoverable part of a path set up along an original route along links between nodes of a communications network, the method having the steps of:
detecting a defect in the original route of the path, using a node on the path and outside the recoverable part of the path, the defect being undetectable by nodes within the recoverable part,
sending a reroute message to one or both nodes at a start and end of the recoverable part, and
receiving the reroute message at the one or both nodes and rerouting the recoverable part over the recovery segment in response to receipt of the reroute message.

2. The method of claim 1 having a step of sending a request message from the node at either end of the recoverable part, to one or both of an ingress and an egress node of the path, before the defect is detected, to request the reroute message be sent in case of detection of the defect.

3. The method of claim 2, the request message comprising a notify message with a notify request object comprising an error value indicating the request to reroute.

4. The method of claim 1, the step of detecting the defect being carried out at an egress node of the path.

5. The method of claim 1, the node detecting the defect being an ingress node of the path, and being arranged to detect using a signal returned from an egress node of the path.

6. The method of claim 1, the path comprising an optical path, with regeneration at an intermediate node outside the recoverable part, the detecting of the defect being carried out at the intermediate node.

7. The method of claim 6, the intermediate node being arranged to send a message to one or more of the ingress and egress nodes of the path to cause them to send the reroute message.

8. The method of claim 1, the receiving of the reroute message taking place at the start of the recoverable part and the rerouting comprising sending a path message along the recovery segment.

9. A node for a communications network, the network being arranged to have paths set up over links between nodes of the network, the node having:
a processor arranged to control use of a recovery segment to reroute a recoverable part of a path set up along an original route along links between the node and other nodes of the communications network, and having:
a detector for detecting a defect in the original route of the path, for the case that the node is outside the recoverable part of the path, and the defect being undetectable by nodes within the recoverable part, and wherein:
in response to the detecting of the defect, the processor is arranged to cause a reroute message to be sent to one or both nodes at ends of the recoverable part, to reroute the recoverable part using the recovery segment.

10. The node of claim 9, arranged to receive a request message from the node at either end of the recoverable part before the defect is detected, to request the reroute message be sent in case of detection of the defect.

11. The node of claim 10, the request message comprising a notify message with a notify request object comprising an error value indicating the request to reroute.

12. The node of claim 9, the node being an egress node of the path.

13. The node of claim 9, the detector being arranged to monitor if the defect is affected by the rerouting.

14. The node of claim 9, the node being an ingress node of the path, and being arranged to detect using a signal returned from an egress node of the path.

15. The node of claim 1, the node being an intermediate node, the path comprising an optical path, the node having a regenerator for regenerating an optical signal on the optical path.

16. The node of claim 15, being arranged to send a message to one or more of the ingress and egress nodes of the path to cause them to send the reroute message.

17. A computer program on a computer readable storage medium having instructions for controlling a node of a communications network and which when executed by a processor of the node cause the node to control use of a recovery segment to reroute a recoverable part of a path set up along an original route along links between the node and other nodes of the communications network, by recognising an input indicating a detection of a defect in the original route of the path, for the case that the node is outside the recoverable part of the path, and the defect is undetectable by nodes within the recoverable part, and in response to the indication of the defect, causing a reroute message to be sent to one or both nodes at ends of the recoverable part, to reroute the recoverable part using the recovery segment.

18. A node for a communications network, the network being arranged to have paths set up over links between nodes of the network, the node having:
a routing part arranged to rerouting a recoverable part of a path from an original route along links between the node and other nodes of the communications network, to use a recovery segment, for the case that the node is at one end of the recoverable part, and a processor arranged to recognise a reroute message received from another node outside the recoverable part of the path, and in response to the reroute message, control the routing part to reroute the path to use the recovery segment.

19. The node of claim 18, arranged to send a request message from the node at either end of the recoverable part before the defect is detected, to request the reroute message be sent in case of detection of the defect.

20. The node of claim 19, the request message comprising a notify message with a notify request object comprising an error value indicating the request to reroute.

21. The node of claim 18, the node being operable as a branching node of the recoverable part.

22. The node of claim 18, the node being operable as a merging node of the recoverable part.

23. The node of claim 18, arranged to carry out the rerouting by sending a path recovery message along the recovery segment to set up the path along the recovery segment.

24. The node of claim 18, and arranged to carry out the rerouting by selecting one or other of duplicate versions of traffic arriving at the node from the recoverable part and from the recovery segment.

25. A computer program on a computer readable storage medium having instructions for controlling a node of a communications network located an endpoint of a recoverable part of a path through nodes of the network, such that when the instructions are executed by a processor of the node, they cause the processor to recognise a reroute message received from another node outside the recoverable part of the path, and in response, to reroute the recoverable part from an original route along links between the node and other nodes of the communications network, onto a recovery segment.
